(19) United States
(12) Patent Application Publication
(10) Pub. No.: US 2009/0243801 A1
(43) Pub. Date: Oct. 1, 2009

(54) Method and System for Utilizing an RFID Sensor Tag as RF Power Measurement Embedded in Antenna

(76) Inventor: Martin Strzelczyk, Rockville, MD (US)

Correspondence Address: MOTOROLA, INC., 1303 EAST ALGONQUIN ROAD, IL01/3RD, SCHAUMBURG, IL, 60196, US

(21) Appl. No.: 12/059,835

(22) Filed: Mar. 31, 2008

(51) Int. Cl. H04Q 5/22

(52) U.S. Cl. 340/10.1

(57) ABSTRACT

Described are a method and a system for measuring radio frequency (“RF”) power utilizing a radio frequency identification (“RFID”) sensor tag embedded in an antenna. The method includes receiving at a communication device, a RF power level measurement from a sensor, adjusting an RF power level of the communication device based on the received power level measurement, wherein the sensor is external to the communication device. The system includes a sensor producing an RF power level measurement, and a communication device transmitting an RF signal and connected to the sensor, the communication device receiving the power level measurement from the sensor and adjusting a power level of the RF signal transmitted by the communication device based on the received RF power level measurement.

### FIELD OF INVENTION

The present application generally relates to systems and methods for measuring radio frequency (“RF”) power utilizing a radio frequency identification (“RFID”) sensor tag embedded in an antenna. Specifically, the system and methods allow for a power output of an RFID reader to be measured and adjusted during operation and thus, permit the emission of RF energy within permissible regulated level.

### BACKGROUND

RFID technology may be described as systems and methods for non-contact reading of targets (e.g., product, people, livestock, etc.) in order to facilitate effective management of these targets within a business enterprise. Specifically, RFID technology allows for the automatic identification of a target, storing target location data, and remotely retrieving target data though the use of RFID tags, also called transponders. The RFID tags are an improvement over standard bar codes since the tags may have read and write capabilities. Accordingly, the target data stored on RFID tags can be changed, updated and/or locked. Due to the ability to track moving objects, RFID technology has established itself in a wide range of markets including retail inventory tracking, manufacturing production chain and automated vehicle identification systems. For example, through the use of RFID tags, a retail store can see how quickly the products leave the shelves, and gather information on the customer buying the product.

Within an RFID system, the RFID tag may be a device that is either applied directly to, or incorporated into, one or more targets for the purpose of identification via radio signals. A typical RFID tag may contain at least two parts, wherein a first part is an integrated circuit for storing and processing information, as well as for modulating and demodulating a radio signal. The second part is an antenna for receiving and transmitting radio signals including target data. A typical RFID reader may contain a radio transceiver and may be capable of receiving and processing these radio signals from several meters away and beyond the line of sight of the tag.

Passive RFID tags may rely entirely on the RFID reader as their power source. These tags are read from a limited range and may have a lower production cost. Accordingly, these tags are typically manufactured to be disposed with the product on which it is placed. Unlike the passive RFID tags, active RFID tags include their own internal power source, such as a battery. This internal power source may be used to power integrated circuits of the tag and broadcast the radio signal to the RFID reader. Active tags are typically much more reliable than passive tags, and may be operable at greater distances from the RFID reader. Since these tags contain more hardware than passive RFID tags, they are more expensive. Active and semi-passive tags are reserved for costly items that are read over greater distances.

### SUMMARY OF THE INVENTION

The present invention relates to a method and a system for measuring radio frequency (“RF”) power utilizing a radio frequency identification (“RFID”) sensor tag embedded in an antenna. The method includes receiving at a communication device, a RF power level measurement from a sensor, adjusting an RF power level of the communication device based on the received power level measurement, wherein the sensor is external to the communication device. The system includes a sensor producing an RF power level measurement, and a communication device transmitting an RF signal and connected to the sensor, the communication device receiving the power level measurement from the sensor and adjusting a power level of the RF signal transmitted by the communication device based on the received RF power level measurement.

### BRIEF DESCRIPTION OF THE DRAWINGS

FIG. 1 shows an exemplary embodiment of a portion of the circuitry 100 within a standard RFID reader 105.

FIG. 2 shows a portion of the circuitry 200 within a sensor-aware RFID 205 reader according to an exemplary embodiment of the present invention.

FIG. 3 shows an exemplary method for managing the RF power levels of the sensor-aware RFID reader according to the exemplary embodiments of the present invention.

FIGS. 4a-4c show an exemplary system for managing the RF power levels of the sensor-aware RFID reader according to the exemplary embodiments of the present invention.

### DETAILED DESCRIPTION

The present invention may be further understood with reference to the following description of exemplary embodiments and the related appended drawings, wherein like elements are provided with the same reference numerals. The present application generally relates to systems and methods for measuring RF power utilizing a radio frequency identification (“RFID”) sensor tag embedded in an antenna. Specifically, the systems and methods may allow for a power output of an RFID reader to be measured and adjusted during operation and thus, permit the emission of RF energy within permissible regulated level.

According to the exemplary embodiment of the present invention, an exemplary RFID system may typically contain RF cabling, as well as RF switches and other coupling devices between one or more reader output ports and an antenna. These elements may attenuate the RF power before it can be radiated from the system. The power outputs of the reader may typically be calibrated at the port in order to meet regulatory emissions requirements. Therefore, the actual net radiated power not only falls below the allowable regulatory limits, but also falls below an intended level of radiation. Accordingly, the resulting loss of energy output within the RFID system will impair the activation and communication to the RFID tags, thereby degrading the overall performance of the system.

While including these path losses in the regulatory approval process may counterbalance this degradation in performance, the effect remains that these items may only be permissible for use as a fixed set. Thus, this solution may result in inflexibility. However, as described above, the exemplary embodiments of the present invention may allow for the power output of the RFID reader to be measured and adjusted during the operation of the reader. Therefore, the loss properties associated within the RF cabling and RF switches may be offset.

The exemplary embodiments of the present invention may provide sensors to RFID tags. According to one embodiment, the systems and methods may be employed within a fixed RFID reader, such as an integrated RFID shelf reader system. For example, the RFID tags of the system may be embedded with one or more antennas, such as a smart antenna within a reader system. Specifically, the exemplary embodiments of the present invention may calibrate the output power at the antennas of a shelf reader system. This may ease installation and reduce cost by eliminated the overlay switching system. Those skilled in the art will understand that the RFID system according to the present invention may also be used to describe any type of RFID reader in accordance with the principles and functionality described herein. Thus, the use of an RFID shelf reader in exemplary systems and methods is only exemplary.

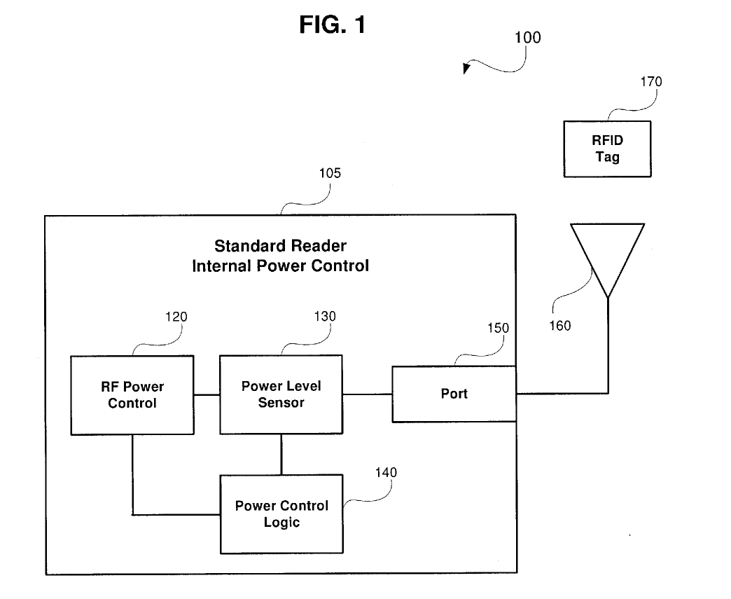

FIG. 1 shows a portion of the circuitry 100 within a standard RFID reader 105 to which the present invention may be applied. Specifically, the circuitry 100 may include an internal power control architecture allowing the standard RFID reader 105 to communicate with an exemplary RFID tag 170. Specifically, the circuitry 100 may include an RF power control 120, a power level sensor 130, a power control logic 140, an antenna port 150, and an antenna 160. The RF power control 120 may adjust the output power of the standard RFID reader 105 in order to comply with regulations. Furthermore, the power level sensor 130 may provide the RF power control 120 with feedback, such as power output levels.

As described above, the RF power control 120 may calibrate the power outputs of the standard RFID reader 105 at the antenna port 150. However, since the reading made by the power level sensor 130 are performed internally at the antenna port 150, the power outputs are calibrated within the RFID reader 105, before the output is radiated outside of the RFID reader 105. Therefore, any loss in the power output caused by the interposing cabling and switches may occur after the power level sensor 130 has provided a power reading to the RF power control 120. Thus, the power radiated from the RFID reader 105 may be below the intended levels of radiation (e.g., further below the regulatory limits).

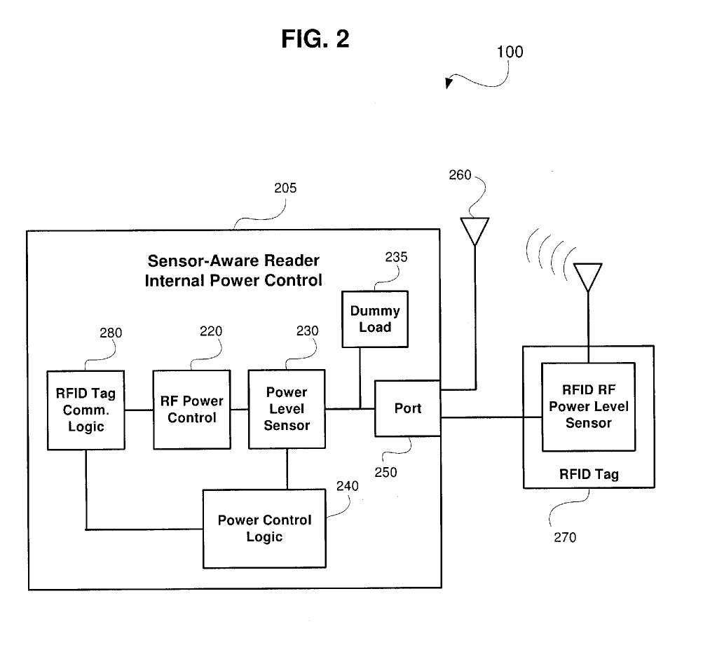

FIG. 2 shows a portion of the circuitry 200 within a sensor-aware RFID reader 205 according to an exemplary embodiment of the present invention. Specifically, the circuitry 200 may include an internal power control architecture allowing the RFID reader 205 to communicate with an exemplary RFID tag 270. Similar to the architecture of the standard RFID reader 105, the circuitry 200 may include an RF power control 220, a power level sensor 230, a power control logic 240, an antenna port 250, and an antenna 260. However, unlike the standard RFID reader 105, the sensor-aware RFID reader 205 may use a communication link with the RFID tag 270 as a feedback path, wherein a first half of the path the is a wired communication from the reader 205 to the tag 270 and a second half of the path is a wireless communication from the tag 270 back to the reader 205. Accordingly, the sensor-aware RFID reader 205 may further include an RFID tag communication logic 280 for interpreting the wireless communication received from the tag 270. In one exemplary embodiment, the sensor-aware RFID reader 205 may also an RF termination (e.g., a “dummy load” 235) for testing purposes. The dummy load will be described in greater details below.

According to the exemplary embodiments, the sensor-aware RFID reader 205 may communicate with the RFID tag 270 through a closed-loop configuration. As will be described in further detail below, the RFID tag 270 may include an RFID RF power level sensor 275. Furthermore, the RFID tag 270 may be linked directly to the circuitry 200 of the RFID reader 205 via a wired connection. The RF power level sensor 275 may be able to measure the power level emitted from the RFID reader 205 at the antenna port 250, external to the reader 205. The power level measurement data obtained by the RFID tag 270 may be communicated back to the RFID tag communication logic 280 of the reader 205 via a wireless communication (i.e., using any RFID communication techniques). This data may be used by the RF power control 220 in order to adjust the RF levels of the reader 205. Therefore, a closed-loop communication may be formed that extends to the point of radiation, as opposed to within the circuitry 200, at the antenna port 250. Thus, power level adjustments may be performed independent of the path to the antenna 260.

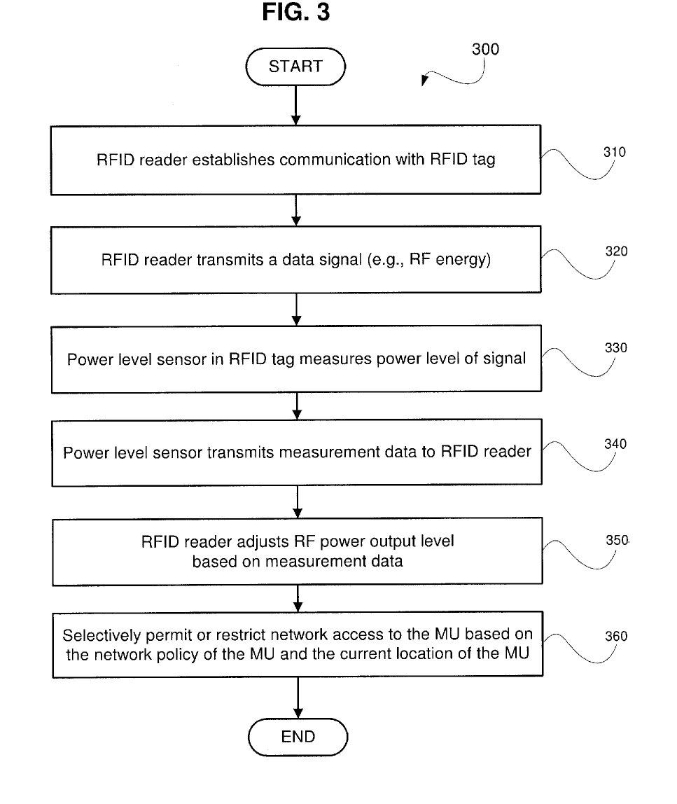

FIG. 3 shows an exemplary method 300 for managing the RF power levels of the sensor-aware RFID reader 205 according to the exemplary embodiments of the present invention. The exemplary method 300 will be described with reference to the exemplary circuitry 200 within a sensor-aware RFID reader 205 of FIG. 2. According to the exemplary method 300, the power output of the RFID reader 205 may be measured at the RFID tag 270, external to the reader 205.

In step 310, the RFID reader 205 may establish a communication with the RFID RF power level sensor 275 of the RFID tag 270. As described above, this communication may be accomplished by a wired communication connected directly to the circuitry 200 of the RFID reader 205. Specifically, the RFID tag 270 may communicate with the RF power control 220 via the RFID tag communication logic 280. It should be noted that the RFID reader 205 may be able to positively identify the direct connection with the RFID tag 270. For example, since the exemplary systems and methods may allow for the power output of the RFID reader 205 to achieve levels above regulatory requirements, it may be advantageous to ensure the output power is being measured and adjusted when the reader 205 is connected to the tag 270.

However, this may not be an issue as the RFID tag 270, as well as the RFID RF power level sensor 275, may be intrinsically identifiable and classifiable entities. Specifically, the RFID tag 270 may be identifiable by stored identifier data, such as an electronic product code (“EPC”), a custom ID, etc. Furthermore, the RFID reader 205 may identify itself through various mechanisms, such as the ability to write to a memory location in the tag 270. It should be noted that the reader 205 may be configured to transmit to the tag 270 en route to the “outside” world because the tag 270 is embedded within the antenna. Therefore, there may be an inherent ability for the RFID reader 205 not to operate over an established emission limit.

According to one embodiment of the exemplary method 300, in step 320, the RFID reader 205 may transmit a data signal (e.g., modulated RF energy) to the RFID tag 270. For example, the RFID reader 205 may transmit at a known initial RF power that is below the regulatory requirements. This may ensure that prior to the sensor 275 receiving the RF signal, there are no transient emissions from the RFID reader 205 at prohibited levels. As will be described below, the power level of the RF signal may be increased as the sensor 275 measures and reports the output power to the RFID reader 205.

According to another embodiment of the exemplary method 300, the RF signal may be directed into a RF termination, or “dummy load” 235, while the output power is being calibrated. Specifically, the dummy load may be substituted for the antenna 260 while the RF power control adjusts the RF power lower. Therefore, the RFID reader 205 may avoid any RF emissions until the power has been adjusted to an appropriate level. As will be described below, once the output power has been calibrated, the power level of the RF signal may be redirected to the antenna port 250 while the sensor 275 measures and reports the output power to the RFID reader 205.

In step 330, the RFID RF power level sensor 275 may measure the power level of the RF signal received from the RFID reader 205. Specifically, the RF power level sensor 275 may be an antenna arrangement embedded into the RFID tag 270. Accordingly, the sensor 275 may receive and evaluate the power level via a wired connection with the circuitry 200 of the RFID reader 205. As noted above, the cabling and switches within the circuitry 200 that are positioned between the RF power control 220 and the antenna port 250 may reduce the power level below the original intended level. However, since the measurements of the sensor 275 are performed external to the circuitry 200 of the RFID reader 205, any reduction to the original power level may be detected and relayed back to the RF power control 220 for further adjustments.

Accordingly, in step 340 the RFID RF power level sensor 275 may transmit the power level measurement data back to the RFID reader 205. Specifically, the measurement data may be communicated back to the RFID reader 205 via RFID communication techniques. The RFID tag 270 may generate the measurement data corresponding the power levels from the sensor 275 and transmits the data back to the RFID reader 205. For example, a modulator within the RFID tag 270 may modulate the measurement data from the sensor 275 onto an RF signal (e.g., a carrier signal transmitted by RFID tag 270), which is received by RFID reader 205 at the antenna port 250.

In step 350, the RFID reader 205 may adjust the RF power output level in response to the measurement data received from the tag 270. Specifically, the measurement data may be extracted from the modulated RF signal generated by the tag 270; this data may be used by the power control logic 240 to properly adjust the power output levels of the RFID reader 205. For example, a demodulator may be coupled to the antenna port 250, wherein the demodulator demodulates the RF signal received from RFID tag 270. Accordingly, the power control logic 240 may receive the demodulated data of the signal from demodulator. The power control logic 240 may then control the operation of RFID reader 205, based on internal logic, contents of a memory, and the measurement data received from the demodulator.

For example, the power control logic 240 may access the memory to determine whether the RF power control 220 should increase or decrease output power based on a transmitted logical “1” or a logical “0”. The RF power control 220 receives the output data from the power control logic 240 and acts accordingly. The power control logic 240 may include software, firmware, and/or hardware, or any combination thereof. For example, power control logic 240 may include digital circuitry, such as logic gates, and may be configured as a state machine in an alternative embodiment.

In step 360, the RFID reader 205 may adjust further receiver properties. Specifically, the RFID reader 205 may utilize the knowledge of the previously known measured path losses within the circuitry 200 to improve the performance and architectural design of the RFID reader 205. For example, the power level sensor 230 within the RFID reader 205 may provide an RF power level measurement internal to the circuitry 200. This internal power level measurement may then be compared to the power level measurement detected by the sensor 275 of the RFID tag 270, external to the circuitry 200. Accordingly, the loss in power output attributed to the circuitry 200 of the RFID reader 205 may be quantified. Thus, this information may be used in adjusting receiver properties, such as gain, in order to increase receive efficacy. Furthermore, this information may be used to evaluate the architecture of the circuitry 200. Thus, the circuitry 200 may be redesigned to reduce the amount of RF power lost by the interposing cables, switches, etc.

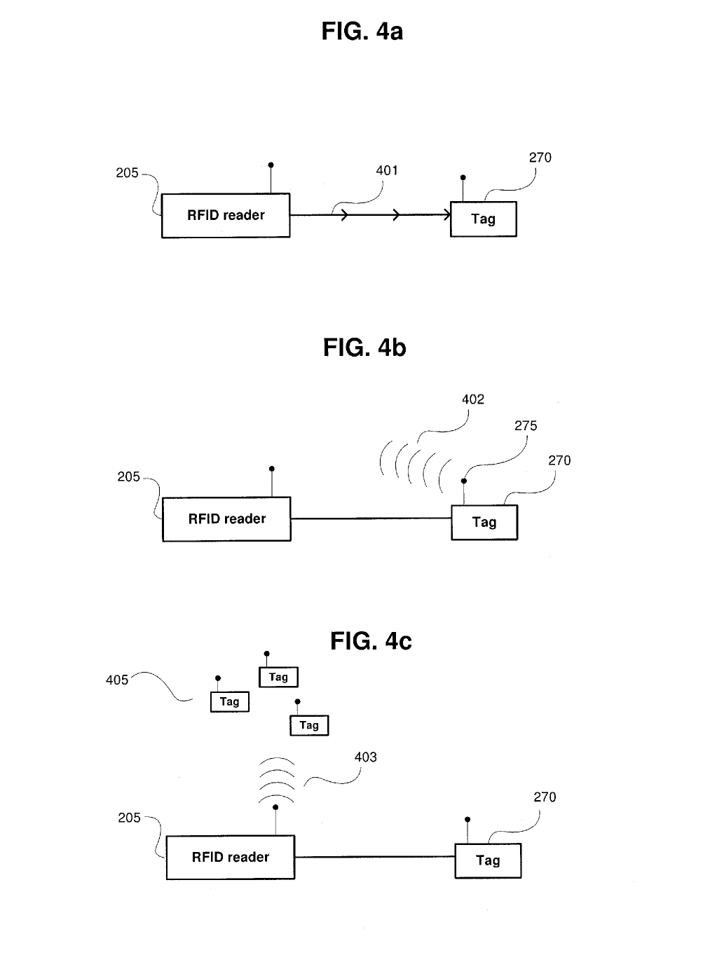

FIGS. 4a-4c show an exemplary system for managing the RF power levels of the sensor-aware RFID reader 205 according to the exemplary embodiments of the present invention. The exemplary system 400 will be described with reference to the exemplary circuitry 200 within a sensor-aware RFID reader 205 of FIG. 2. Specifically, FIGS. 4a-4c illustrate the communication between the RFID reader 205 and the RFID tag 270, as well as the calibration of the RF power levels emitted from the reader 205 based on the communication.

According to one embodiment of the exemplary system 400, the communication between the devices may be a half-duplex communication, wherein the RFID reader 205 and the RFID tag 270 may not modulate simultaneously. Thus, while the exemplary system allows for two-way communication between the RFID reader 205 and the RFID tag 270, this communication may not take place at the same time. Furthermore, this two-way communication may consist of a forward link (from the RFID reader 205 to the RFID tag 270) and a reverse link (from the RFID tag 270 back to the RFID reader 205). While the exemplary RFID tag 270 describe may refer to a single tag, it should be noted that the exemplary embodiments of the present invention allow for the RFID reader 205 to be in communication with a plurality of RFID tags.

In FIG. 4a, the RFID reader 205 may communicate with the RFID tag 270 via a wired connection 401, connected directly to the circuitry 200 of the reader 205. As described above, the RFID RF power level sensor 275 may monitor the power output of the RFID reader 205 during the operation of the RFID reader 205. Accordingly, the wired connection may be attached to the antenna port 250, after the elements within the circuitry 200 (e.g., RF switches, cabling, etc.) have affected the internal RF power level. Since regulatory bodies, such as the Federal Communications Commission (“FCC”), enforce limitations on the RF level radiated from devices, the sensor 275 may ensure that any radiation that emits from the RFID reader 205 will fall within these limitations.

In FIG. 4b, the RFID tag 270 may communicate back to the RFID reader 205 via a wireless transmission 402. As described above, the wireless transmission 402 back to the RFID reader 205 may form a closed-loop that extends the RF power sensing beyond circuitry 200, to the point of radiation. Therefore, the power level reading may be independent of the path in which the signal travels within the RFID reader 205 in order to reach the antenna port 250.

The transmission 402 may utilize any RFID communication techniques in order to inform the RF power control 220 of the current RF power level radiating from the RFID reader 205. Accordingly, the RF power control 220 may be programmed to adjust the output power based on these received measurement data. For example, the RF power control 220 may be calibrated to reduce the output power when the received measurement data exceeds a predetermined threshold value. Conversely, the RF power control 220 may increase the output power when the measurement falls below a predetermined threshold value. Thus, the RF power control 220 may maintain an output power within specific levels (e.g., a window of operation).

In FIG. 4c, the RFID reader 205 may communicate with the RFID tag 270, as well as any additional RFID tags 405, via a wireless signal 403 having a calibrated RF power level. Since the measurement data is independent of the path losses within the RFID reader 205, the performance of the reader 205 may not be hampered and complicated by these unmeasured losses.

In addition, managing the RF output power level on the basis of the external measurements allows for greater flexibility in product design. As opposed to limiting the RF power control 220 to a fixed set of output power levels, the RFID reader 205 may dynamically adjust the operating range of the RF power control 220. Accordingly, if an alteration of the components within the circuitry 200 affects the path losses, the RFID reader 205 may continue to operate at compliant radiation level. These changes in the path losses may be detected by the RFID tag sensor 275 and transmitted back to the RFID reader 205 for power level adjustments.

It will be apparent to those skilled in the art that various modifications may be made in the present invention, without departing from the spirit or the scope of the invention. Thus, it is intended that the present invention cover modifications and variations of this invention provided they come within the scope of the appended claimed and their equivalents.

What is claimed is:

1. A method, comprising:
receiving at a communication device, a radio frequency (“RF”) power level measurement from a sensor; and
adjusting an RF power level of the communication device based on the received power level measurement,
wherein the sensor is external to the communication device.

2. The method according to claim 1, further comprising:
detecting the RF power level from the communication device at the sensor.

3. The method according to claim 1, wherein the RF power level is adjusted by a power control unit of the communication device, the power control unit being configured to maintain the RF power level of the communication device below a predetermined level.

4. The method according to claim 1, wherein the communication device and the sensor are connected via a wire connection.

5. The method according to claim 1, wherein the RF power level is radio frequency output power of an antenna of the communication device.

6. The method according to claim 1, wherein the communication device is a radio frequency identification (“RFID”) reader and the sensor is embedded in an RFID tag.

7. The method according to claim 1, further comprising:
comparing the RF power level measurement to an internal RF power level measurement within the communication device; and
determining a magnitude of a difference between the RF power level measurement and the internal RF power level measurement.

8. The method according to claim 7, further comprising:
adjusting a receiver property of the communication device based on the determined magnitude.

9. A system comprising:
a sensor producing an RF power level measurement; and
a communication device transmitting an RF signal and connected to the sensor, the communication device receiving the power level measurement from the sensor and adjusting a power level of the RF signal transmitted by the communication device based on the received RF power level measurement.

10. The system according to claim 9, further comprising:
a power control unit within the communication device, the power control unit being configured to maintain the RF power level of the communication device below a predetermined level.

11. The system according to claim 9, wherein the communication device and the sensor are connected via a wire connection.

12. The system according to claim 9, wherein the RF power level is a radio frequency output power of an antenna on the communication device.

13. The system according to claim 9, wherein the communication device is a radio frequency identification (“RFID”) reader and the sensor is embedded in an RFID tag.

14. The system according to claim 9, further comprising:
a path loss measurement component comparing the RF power level measurement to an internal RF power level measurement within the communication device, the path loss measurement component determining a magnitude of a difference between the RF power level measurement and the internal RF power level measurement.

15. The system according to claim 14, wherein at least one property of a receiver within the communication device is adjusted based on the determined magnitude.

16. A system, comprising:
a receiving means for receiving at a communication device, a radio frequency (“RF”) power level measurement from a sensor; and
an RF power level adjusting means for adjusting an RF power level of the communication device based on the received power level measurement,
wherein the sensor is external to the communication device.

17. The system according to claim 16, further comprising:
an RF power level detecting means for detecting the RF power level from the communication device at the sensor.

18. The system according to claim 16, wherein the adjusting means maintains the power level of the communication device below a predetermined level.

19. The system according to claim 16, wherein the power level is radio frequency output power of an antenna on the communication device.

20. The system according to claim 16, wherein the communication device is a radio frequency identification (“RFID”) reader and the sensor is embedded in an RFID tag.

21. The system according to claim 16, further comprising:
a comparing means for comparing the RF power level measurement to an internal RF power level measurement within the communication device; and
a determining means for determining a magnitude of a difference between the RF power level measurement and the internal RF power level measurement.

22. The system according to claim 21, further comprising:
a further adjusting means for adjusting a receiver property of the communication device based on the determined magnitude.
